(19) United States
(12) Patent Application Publication
(10) Pub. No.: US 2024/0296976 A1
(43) Pub. Date: Sep. 5, 2024

(54) METHOD FOR FORMING CONTACT SURFACES BY PEELING THE INSULATION ON THE INSULATED CONDUCTOR BARS FOR ENERGY DISTRIBUTION SYSTEMS

(71) Applicant: EAE ELEKTRIK ASANSOR ENDUSTRISI INSAAT SANAYI VE TICARET ANONIM SIRKETI, Istanbul (TR)

(72) Inventor: Halim MERAL, Istanbul (TR)

(21) Appl. No.: 18/044,363

(22) PCT Filed: Nov. 7, 2022
(86) PCT No.: PCT/TR2022/051251

§ 371 Date: Mar. 7, 2023

(30) Foreign Application Priority Data
Jun. 28, 2022 (TR) 2022010639

(51) Int. Cl. H01B 13/00; H01B 13/06

(52) U.S. Cl. CPC H01B 13/0036; H01B 13/06

(57) ABSTRACT

A method for forming contact surfaces by peeling the insulation on the insulated conductor busbars for energy distribution systems.

### TECHNICAL FIELD

The invention relates to method for forming contact surfaces by peeling the insulation on the insulated conductor busbars for energy distribution systems.

### BACKGROUND OF THE INVENTION

Today, modular compact conductors called busbars are used in energy distribution systems. Each conductor, called busbar, is more preferred because it has high current carrying properties.

It is of great importance to ensure the isolation of the mentioned conductors between each other. The said isolation process is generally carried out by coating an insulating material (epoxy) on the aforementioned conductor bar. However, this isolation needs to be partially removed for various applications.

The best example of this is modular electricity distribution systems. In the modular electricity distribution systems, the insulation of the additional zone and the current receiving windows should not be done. However, the process of covering the said conductors with insulating material is done as a whole, and a regional coating process is a costly and long process.

In current applications, isolation masking method is used in order not to cover the areas that should not be insulated. In the aforementioned method, the areas where epoxy coating is not desired are wrapped with glass fiber tape, epoxy coating is made in that way, and then the tapes are removed.

Yet another method is to remove the insulators or cause discontinuity with methods such as scraping and screening after the entire conductor is covered.

When the aforementioned methods are used, preliminary preparation and subsequent cleaning are required. After the scraping of the said insulation material, the conductors can be damaged and cause it to not fulfill its main purpose or shorten the life of the conductor.

In addition, the labor cost of the mentioned processes is high and the production process is long. It is not suitable for automation. Again, in the aforementioned applications, extra material is needed to remove the said insulation, and it causes the material to burn during the baking process. This reveals the deterioration of the material and the necessity of doing the same process again.

One of the methods applied for the removal of insulations is the sandblasting method. As it is known, the sandblasting method is one of the methods used in surface treatments such as removing the coating on the profiles and smoothing the surface.

The mentioned sandblasting method is an application in which metal granules are sprayed on the metal surface to be surface treated with the help of a nozzle at high pressure. In busbar systems, epoxy removal is carried out by applying the sandblasting method to the contact points of the conductive busbars coated with epoxy.

However, epoxy is a flexible material and this coating process is done as a very thick layer (Approximately 500 microns). The flexibility of the epoxy material is not a desirable condition for the sandblasting process. Because the sprayed granules spring when they want to peel the surface and cannot perform a peeling process as desired.

Another problem is that the 0.5 mm thick insulation cannot be peeled off with the sandblasting method in the desired cycle times.

Regarding the subject in the patent application numbered TR 2016 13693 in the literature, “The invention is related to the method of removing the insulating coatings coated on the conductive surface in order to provide insulation between the busbar conductors used in electrical distribution systems in areas where insulation is not desired.” statements are included.

In the mentioned application, the method of exposing the insulating material to heat and vibration in order to remove the insulators coated on the busbar conductors in the busbar configurations from the desired region is disclosed.

Again, in the European patent document numbered EP3555981B1 in the literature, “A method of manufacturing a multi-phase busbar comprising a first and second conducting layer made of a sheet metal, with first and second conducting pins mounted thereat, wherein the conducting layers are mechanically interconnected to each other and electrically insulated from each by cured resin and comprise a first and second connection area at its opposing end portions is characterized by the method steps of providing a first and a second holding element, each having a base body with slot shaped receiving pockets formed therein for receiving a connecting area of one of said conducting layers inserting said first and second connecting areas in said slot shaped receiving pockets of said holding elements, placing said first and second holding elements with said conducting layers in a mold and filling up said mold with liquid curable resin, curing said resin.” statements are included.

In said embodiment, the first and second insulating layers have a thickness of one to a few millimeters, especially 1 mm to 5 mm or more than 5 mm, and completely cover said sheet metal outside of said connection areas; and a method of bonding said first and second insulating layers directly onto each other.

Again, in the European patent document numbered EP2586038B1 in the literature, “An electrical conductor provided with an electrical insulation system surrounding the conductor 1, the insulation comprises a first insulation layer 2 surrounding the conductor and a second insulation layer 3 surrounding the first insulation layer 2. The second insulation layer 3 comprises a second polymer and a second filler in the form of chromium oxide (Cr2O3), iron oxide (Fe2O3), or a mixture of chromium oxide and iron oxide, wherein the first insulation layer 2 comprises a first polymer and a first filler comprising dispersed nanoparticles.” statements are included.

In the aforementioned patent, the electrical conductor production method is disclosed together with the surrounding electrical insulation.

For the reasons mentioned above, a new method of forming contact surfaces by peeling the insulation on the insulated conductor busbars was needed for energy distribution systems.

### Purpose of the Invention

Starting from this position of the technique, the aim of the invention is to reveal a new method of forming contact surfaces by peeling the insulation on the insulated conductor busbars was needed for energy distribution systems that eliminates the existing disadvantages.

Another aim of the invention is to present a structure that allows the insulation of 0.5 mm thickness, 40×160 mm×mm, to be peeled off within 10 seconds.

Another aim of the invention is to present a structure that does not create any waste harmful to the environment and people during the process.

Another aim of the invention is to provide an insulation removal method and a structure that prevents the busbars from being damaged.

### DETAILED DESCRIPTION OF THE INVENTION

In this detailed explanation, the innovation that is the subject of the invention is only explained with examples that will not have any limiting effect for a better understanding of the subject.

The invention is a method of forming contact surfaces by peeling the insulation on the insulated conductor busbars which includes the method steps of covering all the conductive surfaces of the conductive busbars used in energy distribution systems with insulating material, peeling of the additional area, current intake windows and contact areas of the conductive busbar with completely insulating surface, the conductive surface of which is covered with insulating material, by sandblasting by spraying metal granules on it, characterized in that, includes the method step of making the insulation surface to be peeled brittle by immersing it in nitrogen gas for approximately 5 seconds in order to bring the surface temperature to a value between −50° C. and −70° C. in order to ensure that the sandblasting process yields more efficient results by removing the flexibility of the flexible insulation surface.

In the implementation of the mentioned invention, all conductive surfaces of the conductor bars used in energy distribution systems are covered with insulating material as a first step.

Said insulating material is epoxy material in the preferred application of the invention.

Then, just before the sandblasting method, the insulation surface to be peeled off is immersed in nitrogen gas for approximately 5 s, and the surface temperature is brought to a value between −50° C. and −70° C., making it brittle.

Sand on the stainless-steel grid is sprayed with compressed air at 6.5 bar pressure and 14 m³/d flow rate on the insulation surface, which is brought to the desired temperature range, and the insulation on the surface is peeled off.

1. A method of forming contact surfaces by peeling insulation on insulated conductor busbars which includes the method steps of covering all conductive surfaces of the conductive busbars used in energy distribution systems with insulating material, peeling of the additional area, current intake windows and contact areas of the conductive busbar with completely insulating surface, the conductive surface of which is covered with insulating material, by sandblasting by spraying metal granules on it, further including the method step of making the insulation surface to be peeled brittle by immersing it in nitrogen gas for approximately 5 seconds in order to bring the surface temperature to a value between −50° C. and −70° C. in order to ensure that the sandblasting process yields more efficient results by removing the flexibility of the flexible insulation surface.

2. The method of forming contact surfaces by peeling the insulation on the insulated conductor busbars in accordance with claim 1, further including the method step of sandblasting on the stainless-steel grid with compressed air at a pressure of 5 bar and a flow rate of 14 m³/d.
